(19) United States
(12) Patent Application Publication
(10) Pub. No.: US 2005/0156469 A1
(43) Pub. Date: Jul. 21, 2005

(54) Switching device

(75) Inventors: Takeshi Nishida, Muko-shi (JP); Yasuyuki Masui, Otsu-shi (JP); Takeshi Miyasaka, Otsu-shi (JP)

Correspondence Address: OSHA LIANG L.L.P., 1221 MCKINNEY STREET, SUITE 2800, HOUSTON, TX, 77010, US

(73) Assignee: OMRON Corporation, Kyoto-shi (JP)

(21) Appl. No.: 11/014,681

(22) Filed: Dec. 16, 2004

(30) Foreign Application Priority Data
Dec. 22, 2003 (JP) P2003-425001

(51) Int. Cl. H02K 11/00

(52) U.S. Cl. 310/40 MM; 310/68 A; 310/68 R

(57) ABSTRACT

It is to provide a switching device that can be downsized and improved in reliability of the switching characteristic by making it difficult to damage and deteriorate a permanent magnet that is a component and by improving the shutoff performance. It is a switching device which makes a movable contact into/out of contact with a fixed contact, with a permanent magnet arranged in the vicinity of the fixed contact in a fixed contact terminal provided with the fixed contact on its free end. A narrow portion is formed between the fixed contact and the permanent magnet, hence to form an angle.

### BACKGROUND OF THE INVENTION

1. Field of the Invention

The invention relates to a switching device, and more specifically to a switching device such as an electromagnetic relay, a switch, and a timer of switching currents.

2. Description of the Related Art

As a switching device for breaking a direct current, there has been a hermetically sealed relay, for example, disclosed in Japanese Patent Article 1.

Specifically, a plunger 9 contacts with or separates from a core center 4 according to magnetization or demagnetization of a coil 26 within a hollow cavity 40, and an armature assembly 8 and an armature shaft 10 integrated with the plunger 9 slide in a direction of the shaft, so that a movable contact disk 21 contacts with or separates from fixed contacts 22 and 22.

In the above-mentioned hermetically sealed relay, the arc current generated at the time of bringing the movable contact disk 21 into/out of contact with each of the fixed contacts 22 and 22 is shut off, attracted and extended by magnetic force of a permanent magnet 30 built in each of the fixed contacts 22.

However, in order to shut off the arc current by extending it, a predetermined amount of extension is necessary. In the hermetically sealed relay, however, a structure 3 for accommodating the fixed contact 22 and the movable contact disk 21 cannot be formed in compact size, and there is a limit to downsizing of the device.

According to the above-mentioned hermetically sealed relay, even when the orientation of attaching the permanent magnet 30, that is, polarity is arranged as the specification, when the direction of flowing the current at the use becomes inverted, contrary to the specification, the generated arc current is extended inward and therefore, it becomes difficult to shut off the current. When the hermetically sealed relay is used to switch alternative currents, the direction of the current flow changes regularly in the alternative currents and the arc current generated at a switching time is extended not only outward but also inward. This makes it difficult to assuredly shut off the generated arc current and deteriorates reliability in switching characteristic.

In order to solve the above problem, this applicant proposes a switching device capable of assuredly shutting off the arc current with a fixed contact provided on the distal end of the fixed contact terminal 76 and with a permanent magnet 77 arranged in the vicinity of the fixed contact, in Japanese Patent Application No. 233201/2002 (Patent Article 2).
[Patent Article 1] International Patent Publication No. 510040/1997
[Patent Article 2] Japanese Patent Application No. 233201/2002

As the structure according to the above-mentioned switching device, for example, a structure can be considered in which one fixed contact 3 is provided on the free end of the fixed contact terminal 1 and a permanent magnet 2 is arranged in the vicinity of the fixed contact 3 (FIG. 19), as illustrated in FIG. 19 and FIG. 20. After a movable contact 4 comes into contact with the fixed contact 3, when the arc current 5 occurs at the time of separating (FIG. 19B), the arc current 5 is extended in a direction orthogonal to the direction of the magnetic field according to the Fleming's left-hand rule, under the influence of the magnetic flux of the permanent magnet 2. Further, since the generation source of the arc current 5 moves to a corner made by the permanent magnet 2 and the fixed contact terminal 1, there is a problem that the permanent magnet 2 is easily damaged and deteriorated by the arc heat.

Taking the above problem into consideration, the invention is to provide a switching device that can be downsized and improved in reliability of the switching characteristic by making it difficult to damage and deteriorate a permanent magnet that is a component and by improving the shutoff performance.

### SUMMARY OF THE INVENTION

In order to achieve the above object, the switching device according to the invention, which makes a movable contact into/out of contact with a fixed contact, with a permanent magnet arranged in the vicinity of the fixed contact in a fixed contact terminal provided with the fixed contact on its free end, is designed in that a narrow portion is formed in the fixed contact terminal by forming cut-off portions on the both sides of the fixed contact terminal at a position between the fixed contact and the permanent magnet.

According to the invention, thanks to the narrow portion formed by providing the cut-off portions, an angle is formed in front of the permanent magnet. Here, generation source of the arc current has characteristic of concentrating on an angle. Therefore, even when the arc current occurs between the movable contact and the fixed contact and it is extended at the time of switching off the contact, and the generation source of the arc current moves, the angle formed by the narrow portion becomes the generation source of the arc current and the permanent magnet is prevented from being the generation source of the arc current. As a result, the permanent magnet can be prevented from being damaged and deteriorated by the arc heat.

As the embodiment of the invention, the cut-off portions may be rectangular or arc.

According to the embodiment, similarly to claim 1, since the angle which can be the generation source of the arc current is formed in front of the permanent magnet, the permanent magnet can be prevented from being the generation source of the arc current and a switching device can be obtained in which the permanent magnet can be prevented from being damaged and deteriorated by the arc heat.

### BRIEF DESCRIPTION OF THE DRAWINGS

FIG. 1 is a perspective view showing the embodiment in the case where a switching device according to the invention is applied to a direct current breaking relay.

FIG. 2 is an exploded perspective view of FIG. 1.

FIG. 3 is an exploded perspective view of the relay main body shown in FIG. 2.

FIG. 4 is an exploded perspective view of the electromagnetic block shown in FIG. 3.

FIG. 5 is a partly broken perspective view of a sealing case shown in FIG. 4.

FIG. 6 is an exploded perspective view of the sealing case shown in FIG. 4.

FIG. 7 is an exploded perspective view of a movable contact block shown in FIG. 3.

FIG. 8 is an exploded perspective view of a fixed contact block shown in FIG. 3.

FIGS. 9A and 9B are exploded perspective views of an important portion of the fixed contact block shown in FIG. 8.

FIG. 10A is a perspective view of the insulation case shown in FIG. 3 and FIG. 10B is a variation example of the insulation case.

FIGS. 11A, 11B, and 11C are plan views showing the sealing process.

FIG. 12 is a vertical cross sectional front view of the direct current breaking relay shown in FIG. 1.

FIG. 13 is a partly enlarged cross sectional view of FIG. 12.

FIG. 14 is an enlarged cross sectional view of an important portion of the direct current breaking relay shown in FIG. 12.

FIG. 15 is a vertical cross sectional lateral side view of the direct current breaking relay shown in FIG. 1.

FIG. 16A is a partial perspective view showing the operation principle of the sealing case shown in FIG. 5 and FIG. 16B is a partial perspective view showing the operation principle of the sealing case according to the conventional example.

FIGS. 17A, 17B, and 17C are partial perspective views showing the movement of the generation source of the arc current according to the embodiment.

FIG. 18A is a partial perspective view showing the movement of the generation source of the arc current, continued from FIG. 17C and FIG. 18B is a plan view showing the movement of the generation source of the arc current.

FIGS. 19A, 19B, and 19C are partly perspective views each showing the movement of the generation source of the arc current according to a conventional example.

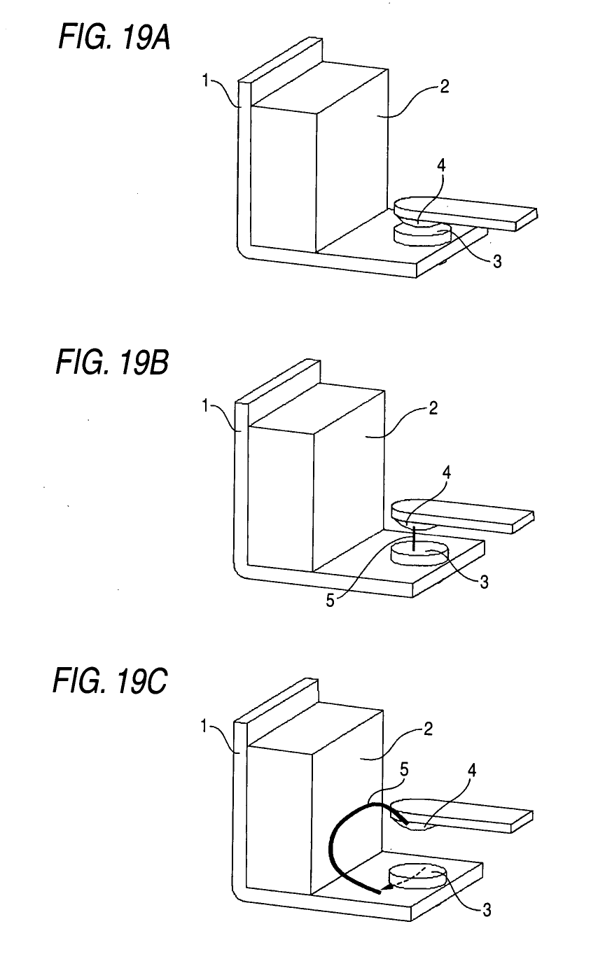

FIG. 20A is a partly perspective view showing the movement of the generation source of the arc current, continued from FIG. 19C, and FIG. 20B is a plan view showing the movement of the generation source of the arc current.

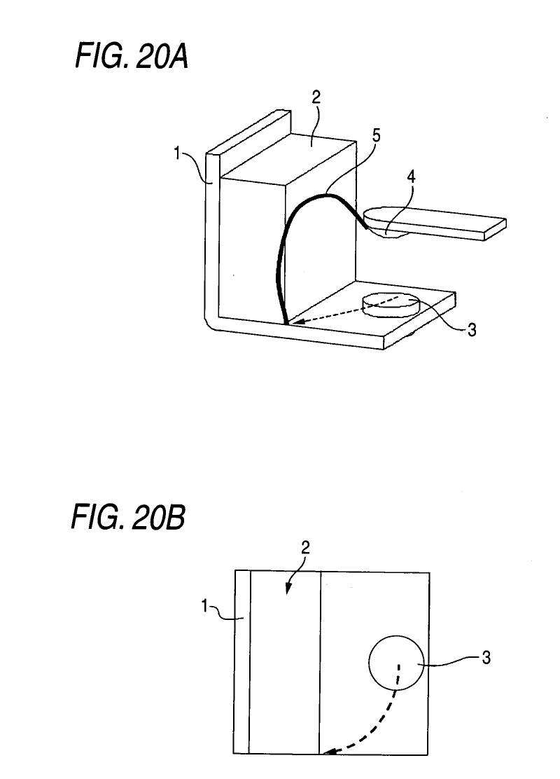

### DETAILED DESCRIPTION OF THE INVENTION

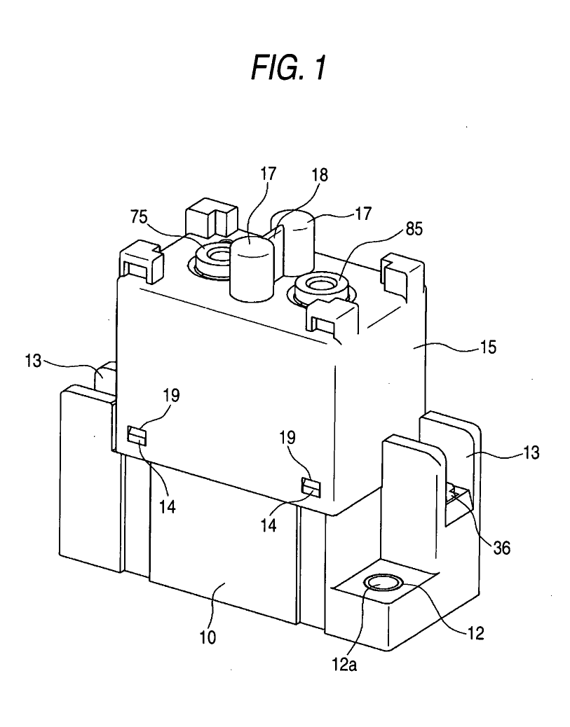

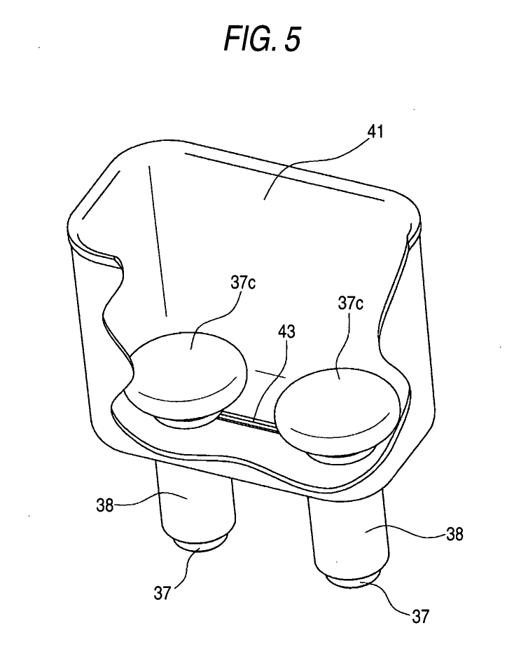

A preferred embodiment of the invention will be described according to the accompanying drawings of FIG. 1 to FIG. 18.

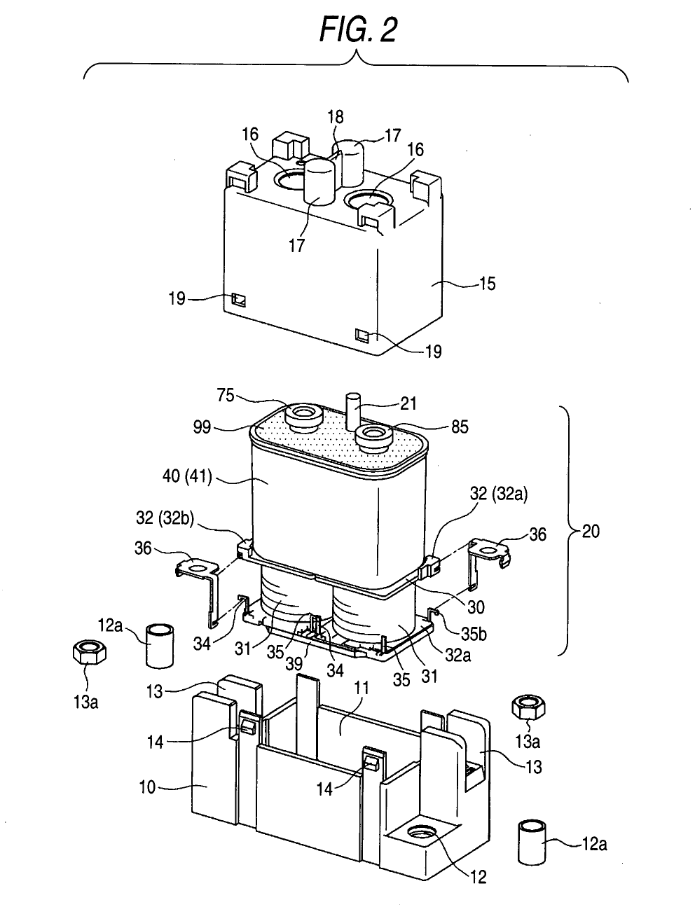

This description will be made in the case where this embodiment is used for a relay for switching a direct current load, and as illustrated in FIG. 1 and FIG. 2, the main body of a relay 20 is housed in a space integrally formed by a box case 10 and a box cover 15.

The box case 10 has a recessed portion 11 capable of housing an electromagnetic block 30 described later, and it is provided with through holes 12 for fixing respectively at two corners positioned on one of the diagonal lines and with jointing concaves 13 at the remaining two corners, as illustrated in FIG. 2. A reinforcing cylinder 12a is inserted into each of the through holes 12 and a joint nut 13a is inserted into each of the jointing concaves 13.

The box cover 15 can be fixed to the box case 10 and it has a shape capable of housing a sealing case block 40 described later. The box cover 15 is provided with contact holes 16 and 16 from which contact terminals 75 and 85 of the relay main body 20 described later protrude respectively as well as with protruding portions 17 and 17 which can accommodate a gas discharge pipe 21, on its ceiling surface. A partition wall 18 connects the both protruding portions 17 and 17 and these work as an insulating wall. Each engagement hole 19 provided on the lower end portion of the box cover 15 is engaged with each engagement claw 14 provided on the upper end portion of the box case 10, hence to combine the both integrally.

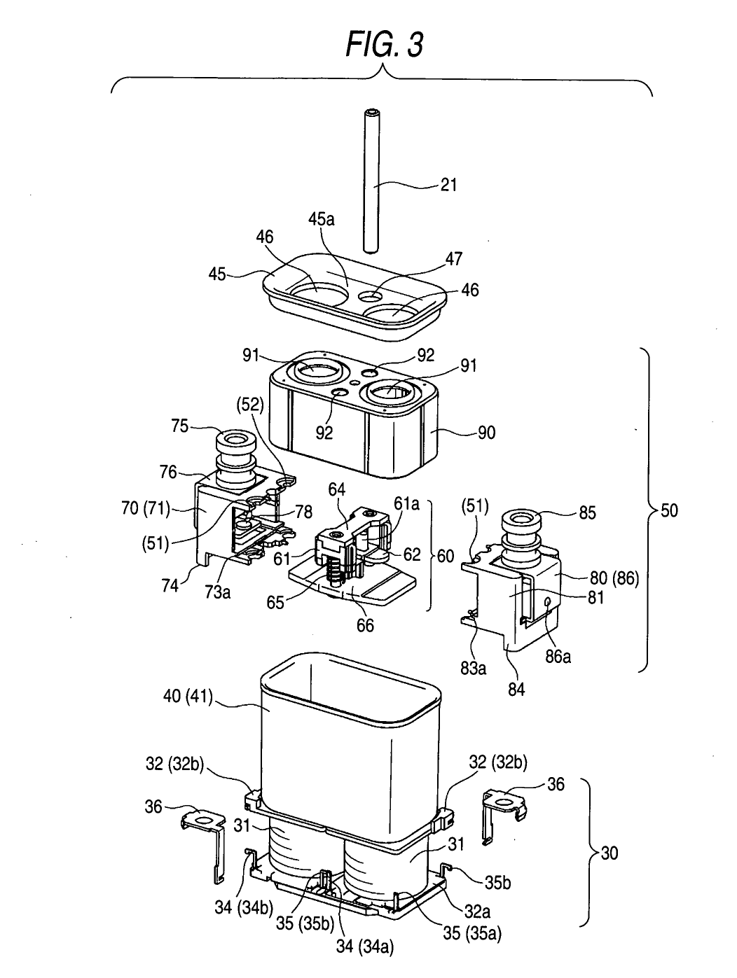

The relay main body 20 is constituted by sealing a contact mechanism block 50 within the sealing case block 40 mounted on the electromagnetic block 30, as illustrated in FIG. 2 and FIG. 3.

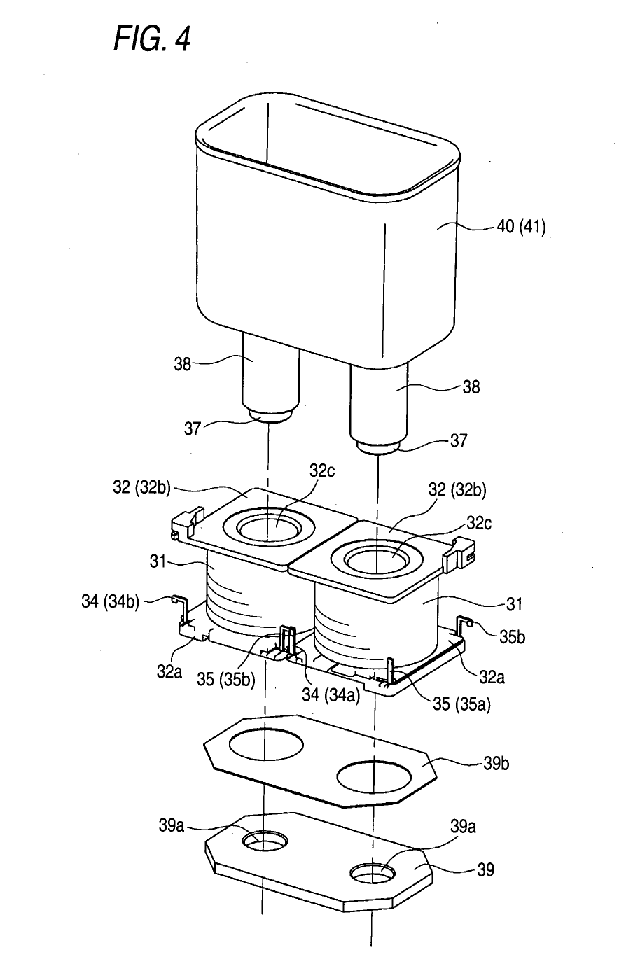

As illustrated in FIG. 4, the electromagnetic block 30 includes a pair of spools 32 and 32 with coil 31 wound around, combined with two iron cores 37 and 37 integrated with the block and a plate-shaped yoke 39.

In the spool 32, relay terminals 34 and 35 are laterally attached to the lower collar portion 32a, of collar portions 32a and 32b provided on the both upper and lower ends. One end of the coil 31 wound around the spool 32 is entwined with one end (entwined portion) 34a of one relay terminal 34 and soldered there and the other end is entwined with the other end (entwined portion) 35a of the other relay terminal 35 and soldered there. In the relay terminals 34 and 35, the entwined portion 34a is curved and the other end (joint portion) 35b is also curved. Of the relay terminals 34 and 35 mounted on the aligned spools 32 and 32, one joint portion 35b of one adjacent relay terminal 35 is jointed to the entwined portion 34a of the other adjacent relay terminal 34 and soldered there. Further, the entwined portion 35a of one adjacent relay terminal 35 is jointed to the joint portion 34b of the other relay terminal 34 and soldered there, hence to connect the two coils 31 and 31. The coil terminals 36 and 36 are bridged over the upper and lower collar portions 32a and 32b of the spools 32 and respectively connected to the joint portions 34b and 35b of the relay terminals 34 and 35 (FIG. 3).

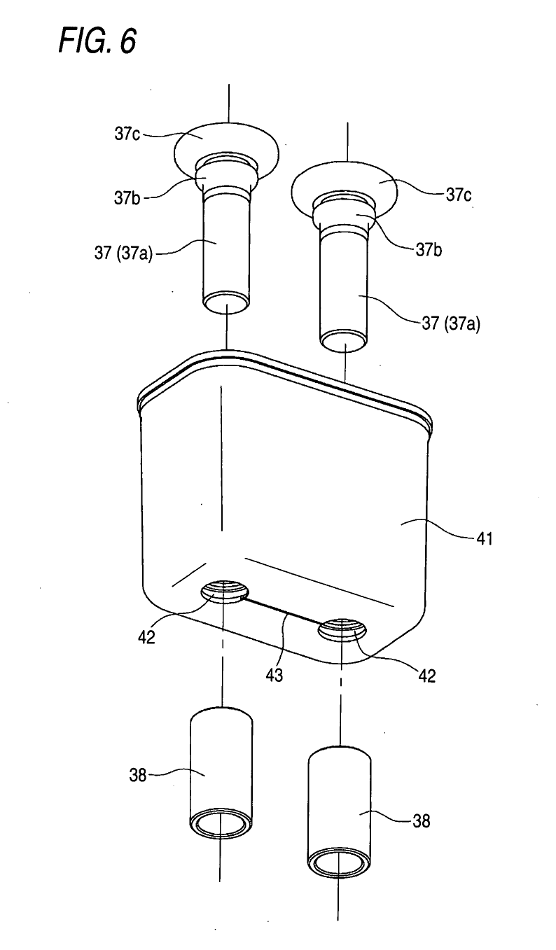

The sealing case block 40 is formed by a sealing case 41 capable of housing the contact mechanism block 50 described later and a sealing cover 45 for sealing the opening portion of the sealing case 41. A pair of fitting holes 42 and 42 for inserting the iron cores 37 is formed on the bottom surface of the sealing case 41 (FIG. 6). A slit 43 for connecting the both holes is provided between the fitting holes 42 and 42. In the sealing cover 45, as illustrated in FIG. 3, a pair of through holes 46 and 46 for penetrating the contact terminals 75 and 85 of the contact mechanism block 50 described later and a loose hole 47 for loosely fitting the gas discharge pipe 21 are provided on the bottom surface of the concave 45a.

Assembling the electromagnetic block 30 and the sealing case block 40 is performed in the following procedure.

At first, the relay terminals 34 and 35 are attached to the collar portion 32a that is placed at one side of the spools 32, the coil 31 is wound around the spools 32, each drawing line is entwined with each of the entwined portions 34a and 35a of the relay terminals 34 and 35 and soldered there. A pair of the spools 32 is aligned with the entwined portions 34a and 35a and the joint portions 34b and 35b of the relay terminals 34 and 35 curved and raised. The entwined portion 35a of the relay terminal 35 is jointed to the joint portion 34b of the other adjacent relay terminal 34 and soldered. The joint portion 35b of the relay terminal 35 is jointed to the entwined portion 34a of the other adjacent relay terminal 34 and soldered there, hence to connect the coils 31 and 31.

As illustrated in FIG. 6, the respective iron cores 37 are inserted into the respective fitting holes 42 provided on the bottom surface of the sealing case 41 and pipes 38 are respectively attached to the shaft portions 37a of the protruding iron cores 37. Each of the pipes 38 is pushed to each of the iron cores 37 from the opening edge of the pipe 38 in a direction of the shaft. In the iron core 37, the diameter of the shaft portion 37a is smaller than the diameter of the fitting hole 42 of the sealing case 41 and smaller than the inner diameter of the pipe 38. The diameter of a bottleneck portion 37b of the iron core 37 is larger than the diameter of the fitting hole 42 of the sealing case 41 and larger than the inner diameter of the pipe 38. Therefore, when the iron core 37 is pushed down in a direction of the shaft, the bottleneck portion 37b of the iron core 37 goes through the fitting hole 42 of the sealing case 41 expanding it and further goes through the pipe 38 expanding the inner diameter of the pipe 38. The opening end portion of the pipe 38 and the head portion (magnetic pole portion) 37c of the iron core 37 are fixedly fitted to the opening portion of the fitting hole 42 upwardly and downwardly. The opening portion of the fitting hole 42 of the sealing case 41 is caulked in three directions.

According to the embodiment, since the sealing case 41 is made from material having the thermal expansion coefficient higher than the iron core 37 and the pipe 38, for example, aluminum, it is effective in securing airtightness even when a temperature changes.

Even when each component expands with an increase in temperature, since the expansion of the sealing case 41 in a thickness direction is relatively larger than that of the other components, the sealing case 41 can be more strongly supported by the head portions 37c of the iron cores 37 and the pipes 38. While, when each component shrinks with a decrease in temperature, since the shrinkage of the fitting hole 42 of the sealing case 41 in a diameter direction is relatively larger than that of the other components, the bottleneck portion 37b of the iron core 37 is choked. In order to retrain generation of thermal stress while securing the airtightness, it is preferable that the thermal expansion coefficient of the iron core 37 is substantially equal to that of the pipe 38.

When the sealing case 41 is made from aluminum that can be easily processed, a sealing work becomes easy and hydrogen becomes difficult to penetrate the case advantageously.

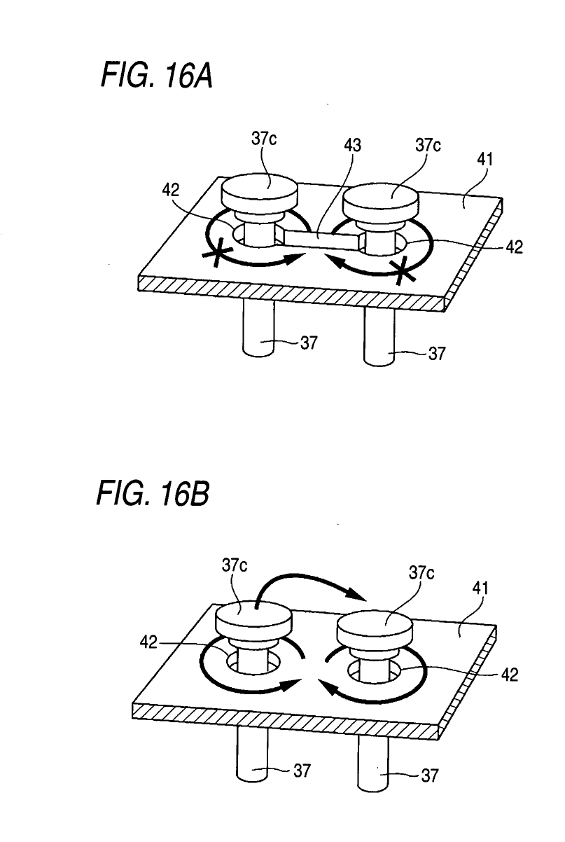

According to the embodiment, since the slit 43 is provided in the bottom surface of the sealing case 41, even when a change of magnetic flux occurs in the iron core 37, eddy currents can be prevented by this slit, as illustrated in FIG. 16. Therefore, by preventing generation of the magnetic flux caused by the above eddy currents, the return operation of a movable iron piece 66 described later can be smoothly performed. This can restrain the deterioration of the blocking performance caused by a delay of the return operation.

A method for preventing the generation of the eddy currents is not restricted to the above method of providing the slit 43 of connecting the fitting holes 42 and 42 but also, for example, at least one cut-off portion individually formed around each of the fitting holes 42 and 42 may be provided. Generation of the eddy currents may be restrained by forming a rough uneven surface around the fitting holes 42 of the bottom surface of the sealing case 41 to increase the electric resistance.

As illustrated in FIG. 4, the respective iron cores 37 and the respective pipes 38 are inserted into respective center holes 32c of the spools 32, so that the respective distal ends of the protruding iron cores 37 go through respective caulking holes 39a of the yoke 39, hence to fix the above components firmly. Thus, the electromagnetic block 30 with the sealing case 41 mounted there is completed. An insulating sheet 39b in order to enhance the insulation performance is arranged between the yoke 39 and the collar portion 32a of the spools 32.

The coil terminals 36 are respectively hung over the upper and lower collar portions 32b and 32a of the spools 32. The lower ends of the coil terminals 36 are respectively connected to the joints portions 34b and 35b of the relay terminals 34 and 35. Hence, an assembly work of the electromagnetic block 30 and the sealing case 41 is completed. The sealing material 98 is injected into the bottom of the sealing case 41 and hardened there, to seal the slit 43. The sealing material 98 is made, for example, by adding alumina powder to an epoxy resin and when it is hardened, it has the almost same line expansion rate as aluminum.

The contact mechanism block 50 comprises a movable contact block 60, fixed contact blocks 70 and 80 mounted on the both sides of the block 60, and an insulation case 90 for housing and unitizing these blocks, as illustrated in FIG. 3.

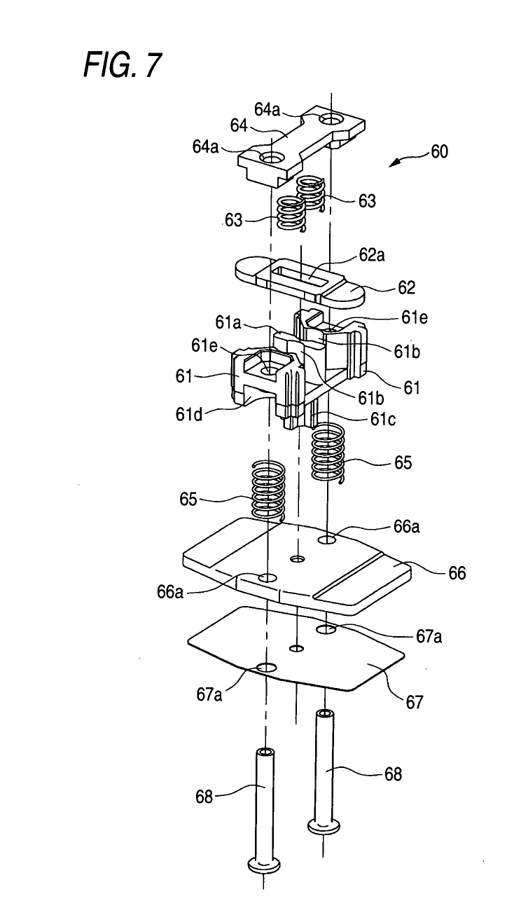

In the movable contact block 60, a movable contact piece 62 and a pair of coil springs 63 and 63 for pressing contact are mounted on a movable insulation base 61 with a stopper 64, as illustrated in FIG. 7. A pair of return coil springs 65 and 65, a movable iron piece 66, and a shielding plate 67 are firmly staked to the movable insulation base 61 with a pair of rivets 68 and 68.

In the movable insulation base 61, deep grooves 61b and 61b are formed on the both sides of a guide protrusion 61a protruding in the center of the base on its upper surface so as to accommodate the coil springs 63 without dropping them. On the bottom surface of the movable insulation base 61, a leg portion 61c having a substantially-cross shaped section is formed in its center and concave portions 61d and 61d (the back concave portion 61d is not illustrated) for positioning the return coil springs 65 are formed on its both sides.

The movable contact piece 62 is designed in that the both ends of band-shaped thick conductive material become semicircle and a guide long hollow 62a is provided in its center. The coil springs 63 are to add a contact pressure to the movable contact piece 62 and to always urge the movable contact piece 62 downward.

In assembling the movable contact block 60, at first, the guide long hollow 62a of the movable contact piece 62 is fitted to the guide protrusion 61a of the movable insulation base 61. Then, a pair of the coil springs 63 and 63 are fitted to the deep grooves 61b and 61b, and the stopper 64 is attached there. The rivets 68 and 68 are inserted into the return coil springs 65 and 65 positioned within the concave portions 61d and 61d of the movable insulation base 61, passing through caulking holes 66a of the movable iron piece 66 and caulking holes 67a of the shielding plate 67. Then, the rivets 68 and 68 are inserted into caulking holes 61e and 61e of the movable insulation base 61 and caulking holes 64a of the stopper 64, thereby staking the above components and completing the assembly work. According to the embodiment, the movable contact piece 62 is always urged downward by the spring force of the coil springs 63 so as not to allow a wobble.

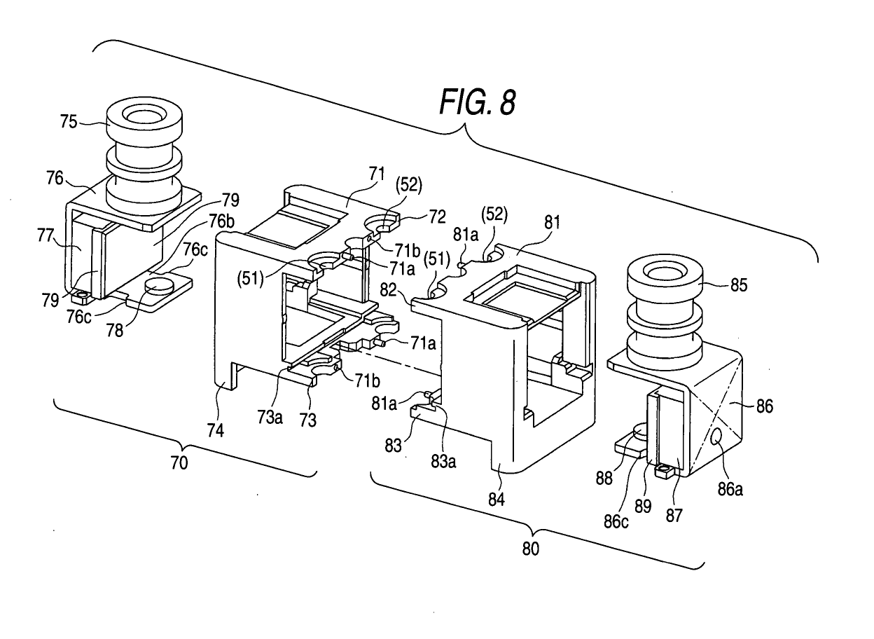

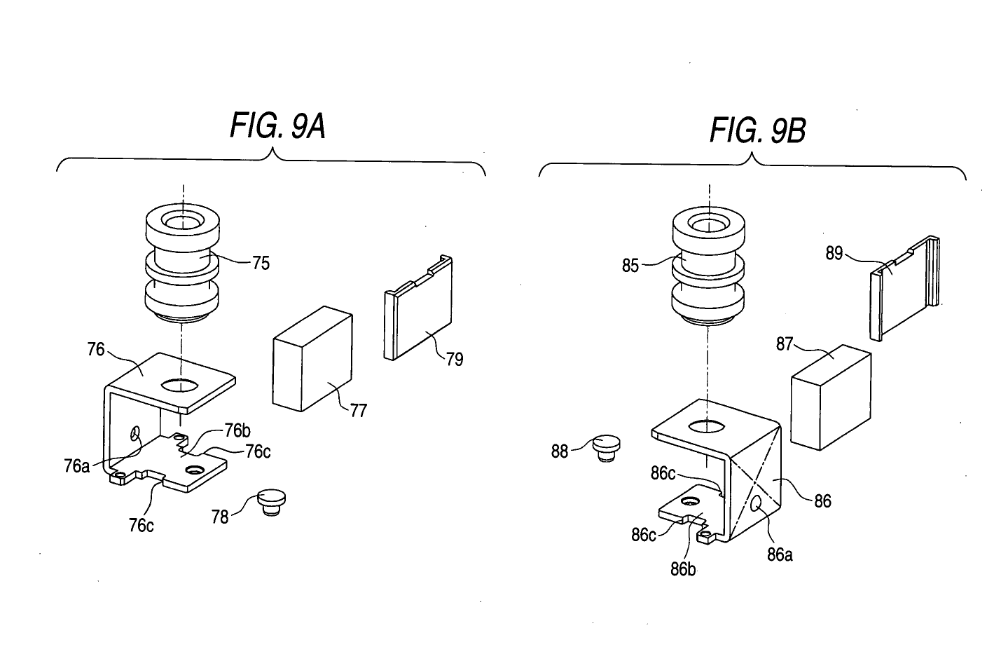

As illustrated in FIG. 8 and FIG. 9, the fixed contact blocks 70 and 80 have the same shape and the same structure. They are formed by attaching the fixed contact terminals 76 and 86 each having a substantially-C-shaped section, with the contact terminals 75 and 85 crimped there, and the permanent magnets 77 and 87, to the fixed contact bases 71 and 81 made from resin.

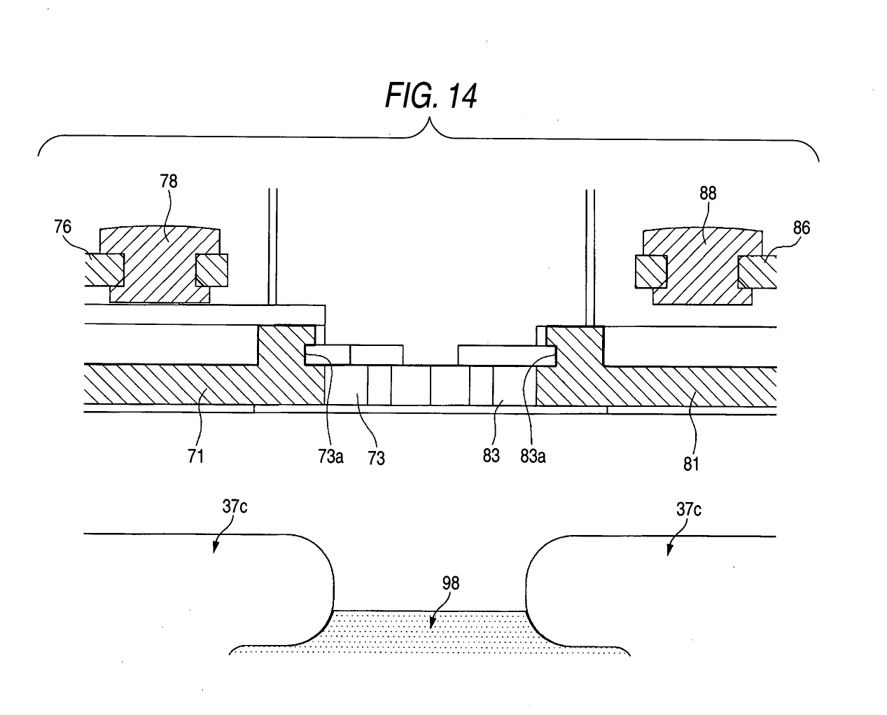

The fixed contact bases 71 and 81 respectively have matching protruding portions 72, 73 and 82, 83 on the upper and lower ends of the bases 71 and 81 on their facing sides. In the protruding portions 72, 73 and 82, 83, in particular, engagement projections 71a and 81a and engagement holes 71b and 81b that can be mutually engaged with each other are formed on the surface of the both edges. Further, in the protruding portions 73 and 83, cut-off grooves 73a and 83a are respectively provided in their basements, as illustrated in FIG. 14, so that they can be a insulating groove in the shape of substantially converted T at the matching time. Even when scattered powder caused at the time of switching contact is scattered around the inner surface, this can prevent the scattered powder from attaching to the inside corners of the cut-off grooves 73a and 83a, so as not to form a short circuit. It is not necessary to always provide with the both cut-off grooves 73a and 83a, but only one may be provided, hence to form an insulating groove having a substantially L-shaped section.

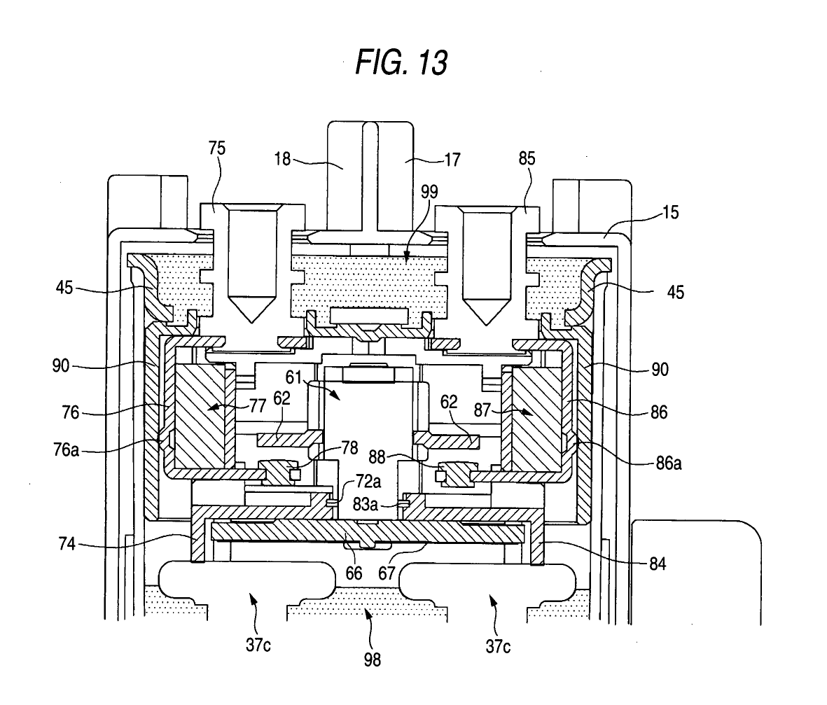

As illustrated in FIG. 8 and FIG. 9, the fixed contact terminals 76 and 86 respectively have the fixed contact portions 78 and 88 crimped on their lower end portions and respectively contain the permanent magnets 77 and 87 in their lower corners. Further, the fixed contact terminals 76 and 86 are respectively provided with positioning projections 76a and 86a each protruding at the position a little lower than the middle of the outer rectangular surface. The projections 76a and 86a come into close contact with the inner surface of the insulation case 90 described later (FIG. 13), hence to regulate the position of the fixed contact terminals 76 and 86 and improve the positioning accuracy of the fixed contacts 78 and 88. The fixed contact terminals 76 and 86 are respectively provided with narrow portions 76b and 86b between the fixed contact portions 78 and 88 and the permanent magnets 77 and 87. This means that angles 76c and 86c are respectively formed in front of the permanent magnets 77 and 87, which prevents generation sources of the arc currents from moving to the permanent magnets 77 and 87.

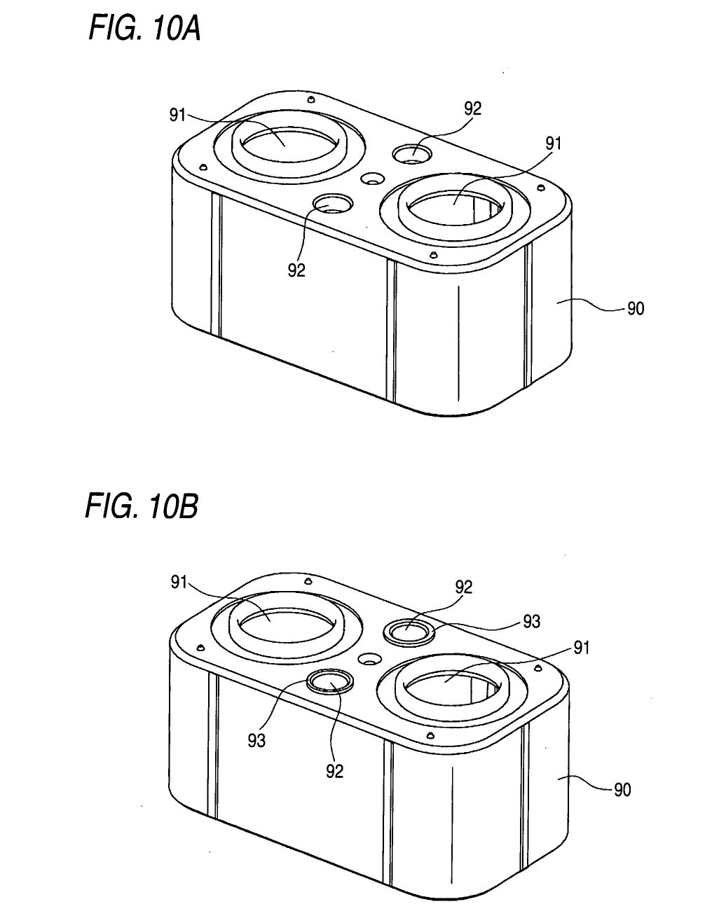

The insulation case 90 is to unitize the contact mechanism block 50, as illustrated in FIG. 3. The insulation case 90 is provided with a pair of the gas discharge holes 92 and 92 on the both sides symmetric with respect to a central line connecting the terminal holes 91 and 91 which are provided on the top surface of the case (FIG. 3 and FIG. 10A). It is in order to make the orientation indifferent in the assembly mode that a pair of the gas discharge holes 92 is provided symmetrically. Each circular protrusion 93 for preventing the intrusion of the sealing material may be integrated with each of the opening ends of the gas discharge holes 92 (FIG. 10B).

The procedure of assembling the contact mechanism block 50 will be described below.

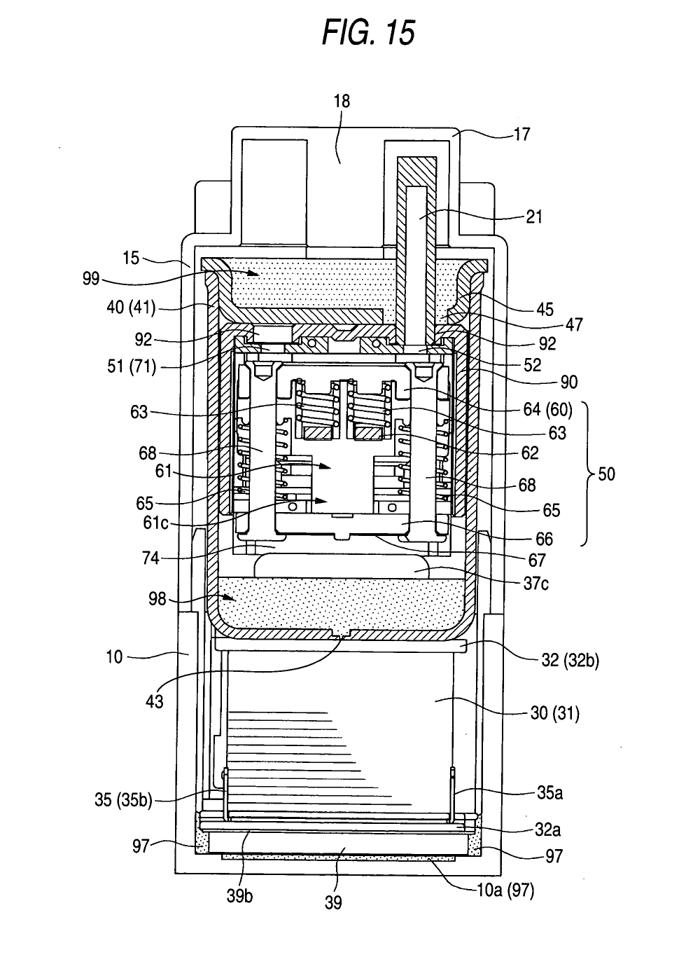

While pulling up each lower end of the return springs 65 of the assembled movable contact block 60, the fixed contact blocks 70 and 80 are attached to the movable insulation base 61 on its both sides, and the engagement projections 71a of the respective matching protruding portions 72 and 73 are respectively engaged into the engagement holes 81b of the respective matching protruding portions 82 and 83, and the engagement holes 71b of the respective matching protruding portions 72 and 73 are engaged with the engagement projections 81a of the respective matching protruding portions 82 and 83. According to this, respective operation holes 51 and 52 are formed between the both fixed contact bases 71 and 81. After attaching the insulation case 90 to the fixed contact blocks 70 and 80, the contact terminals 75 and 85 respectively protrude from the terminal holes 91 and 91, hence to complete the contact mechanism block 50. Here, the gas discharge holes 92 and 92 communicate with the operation holes 51 and 52 since they are positioned on the same axis (FIG. 15).

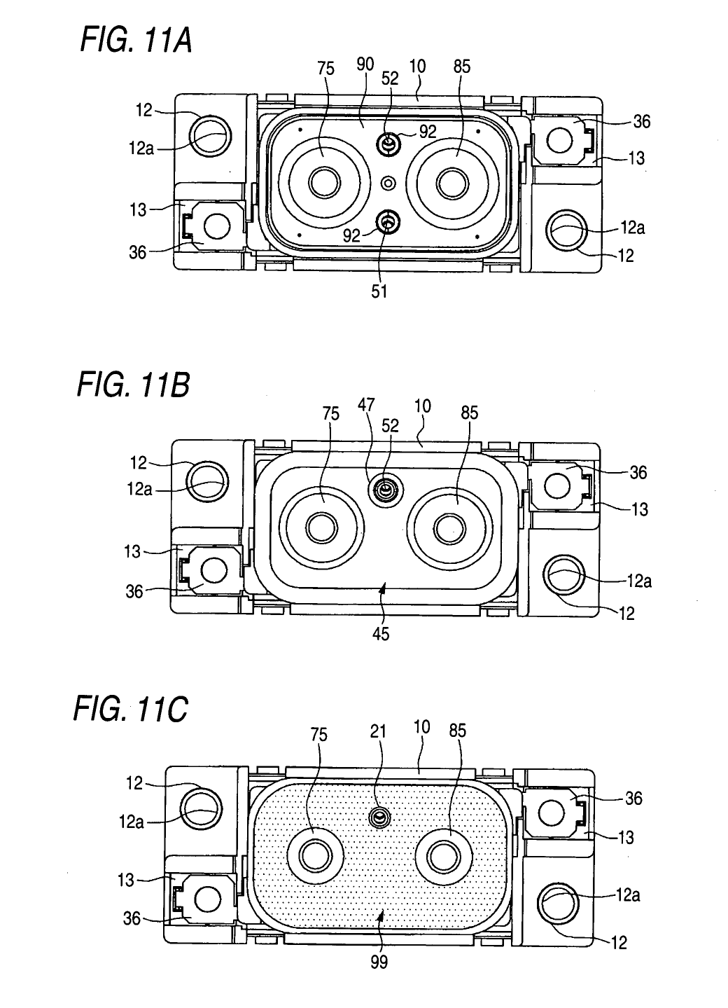

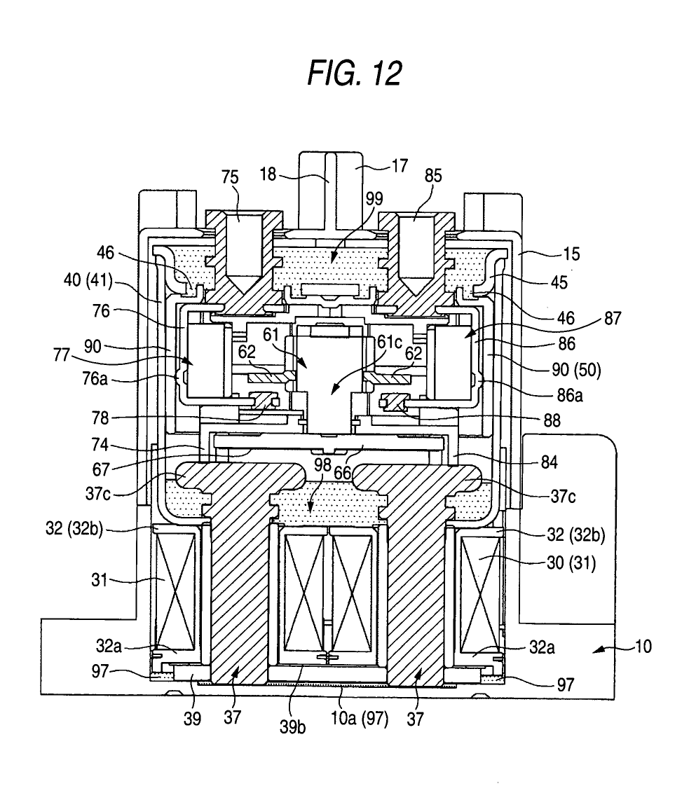

When the contact mechanism block 50 is inserted into the sealing case 41 containing the electromagnetic block 30 (FIG. 12), the leg portions 74 and 84 of the fixed contact bases 70 and 80 respectively come into contact with the head portions 37c that are the magnetic pole portions of the iron cores 37, and the movable iron piece 66 faces the magnetic pole portions 37c through the shielding plate 67 in a removable way. A pair of measurement probes (not illustrated) are respectively inserted into the operation holes 51 and 52 provided between the respective gas discharge holes 92 and 92 of the insulation case 90 and the respective fixed contact bases 71 and 81. The rivets 68 and 68 cramped to the stopper 64 are pushed or released, in order to move the movable contact block 60 up and down and measure the operation characteristics of the contact pressure and the contact gap. As a result, when the operation characteristic is out of the tolerance level, fine adjustment is performed, while when the operation characteristic is within the tolerance level, the sealing cover 45 is attached to the sealing case 41 and they are welded together (FIG. 11B). A gas discharge pipe 21 is pushed into one of the gas discharge holes 92 of the insulation case 90 from the loose hole 47. The same sealing material 99 as the sealing material 98 made from epoxy resin is injected into the sealing cover 45 and hardened there, so as to seal the basement around the contact terminals 75 and 85 and the gas discharge pipe 21 (FIG. 1C). Air within the sealing case 41 is taken out through the gas discharge pipe 21 and a predetermined mixed gas is injected instead, and then the gas discharge pipe 21 is caulked and sealed. At last, the coil terminals 36 are hung on a pair of the collar portions 32a and 32b of the spools 32, hence to complete the relay main body 20 (FIG. 2).

According to the embodiment, one of the gas discharge holes 92 is sealed by the gas discharge pipe 21 and the other is covered with the sealing cover 45. Owing to this structure, even when the sealing material 99 is injected, the sealing material 99 will not intrude into the insulation case 90. Since the loose hole 47 for inserting the pipe 21 is positioned at the position equally distant from the respective contact terminals 75 and 85, it has an advantage that the insulating characteristic is good.

A liquid elastic material 97 made from urethane resin is injected in the bottom surface of the recessed portion 11 of the case 10, and the relay main body 20 is accommodated in the recessed portion 11. The coil terminals 36 are positioned at the jointing concaves 13, and the liquid elastic material 97 is hardened there as it is with the relay main body 20 hung within the case 10. The cover 15 is attached to the case 10, hence to complete the direct current breaking relay. In the embodiment, although the liquid elastic material 97 filled and hardened is noise absorbing elastic material, it is not restricted to this but an elastic sheet may be used as a noise absorbing elastic material. The collar portions 32b of the spools 32 may be extended and hung within the recessed portion 11 of the case 10.

The operation of the relay having the above structure will be described, this time.

When no voltage is applied to the coils 31 of the electromagnetic block 30, the movable insulation base 61 is pulled up by the spring force of the return springs 65 and 65 (FIG. 12). Therefore, the movable iron piece 66 is separated from the magnetic pole portions 37c of the iron cores 37 and the both ends of the movable contact piece 62 are separated from the fixed contacts 78 and 88.

When a voltage is applied to the coils 31, the magnetic pole portions 37c of the iron cores 37 absorb the movable iron piece 66, and the movable iron piece 66 moves down against the spring force of the return springs 65. Thus, the movable insulation base 61 integrated with the movable iron piece 66 moves down, and after the both ends of the movable contact piece 62 come into contact with the fixed contacts 78 and 88, the movable iron piece 66 is absorbed by the magnetic pole portions 37c of the iron cores 37.

According to the embodiment, since the shock when the movable iron piece 66 comes into contact with the magnetic pole portions 37c of the iron cores 37 is absorbed and reduced by the hardened liquid elastic material 97 and the coil terminals 36, collision sound can be restrained, hence to obtain a silent electromagnetic relay advantageously.

When the voltage applied to the coils 31 is stopped, the movable insulation base 61 is raised by the spring force of the return springs 65, the movable iron piece 66 moving together with this is accordingly separated from the magnetic pole portions 37c of the iron cores 37, and the both ends of the movable contact piece 62 are separated from the fixed contacts 78 and 88.

According to the embodiment, when the both ends of the movable contact piece 62 contact with and separate from the fixed contacts 78 and 88, the scattered powder is scattered around the inner surface of the fixed contact bases 71 and 81. However, since the cut-off grooves 73a and 83a are provided on the inner surfaces of the fixed contact bases 71 and 81 as shown by a thick solid line in FIG. 14, the scattered powder will not be attached there fully and a short circuit will not be formed there advantageously.

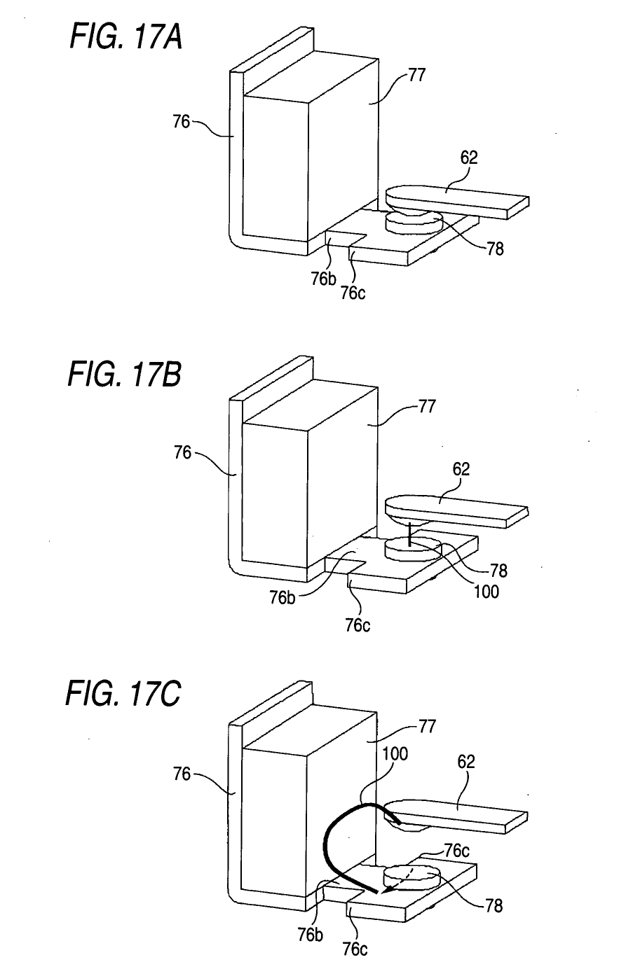

When the both ends of the movable contact piece 62 are separated from the fixed contacts 78 and 88, for example, as illustrated in FIG. 17, even when the arc current 100 is produced and extended from the fixed contact 78 and the generation source of the arc current 100 moves, it will never reach the permanent magnetic 77, which will not damage the permanent magnetic 77 advantageously.

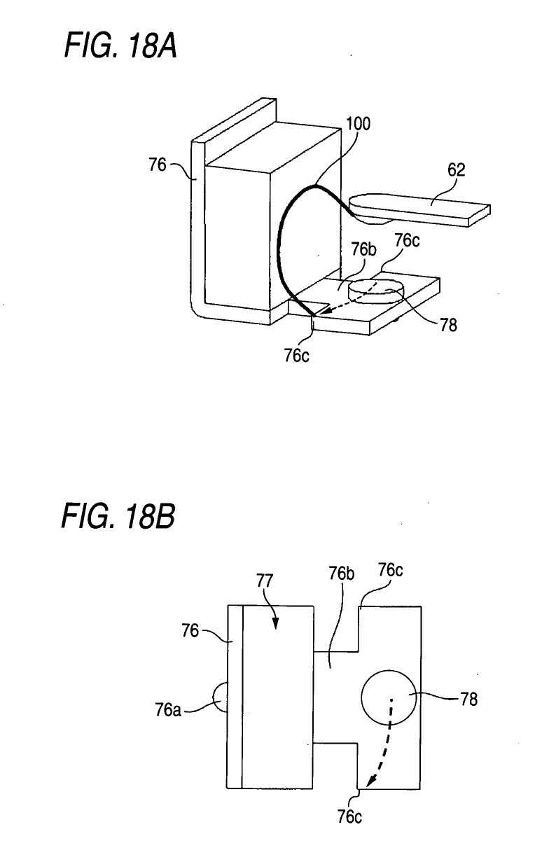

More specifically, as illustrated in FIG. 17, even when the arc current 100 is generated in the fixed contact 78 (FIG. 17B) and the generation source of the arc current 100 is attracted by the magnetic force of the permanent magnet 78 and moves (FIG. 17C, FIG. 18A, FIG. 18B), it will never arrive at the permanent magnet 78. This is because the generation source of the arc current 100 has the characteristic of moving to a corner or an angle of the conductive material. According to the embodiment, the narrow portion 76b is provided between the fixed contact 78 and the permanent magnet 77, hence to form the angle 76c in front of the permanent magnet 77. Therefore, the generation source of the arc current 100 cannot move to the permanent magnet 77 but move to the angle 76c.

In the embodiment, although the case of breaking the direct current has been described, the invention is not restricted to this case but it may be applied to the case of breaking an alternative current.

The invention is not restricted to the above-mentioned electromagnetic relay, but it is needless to say that it may be applied to a switching device such as a switch and a timer.

1. A switching device which makes a movable contact into/out of contact with a fixed contact, with a permanent magnet arranged in the vicinity of the fixed contact in a fixed contact terminal provided with the fixed contact on the free end, in which
a narrow portion is formed by forming cut-off portions on the both sides of the fixed contact terminal at a position between the fixed contact and the permanent magnet.

2. The switching device according to claim 1, in which
the cut-off portions are rectangular.

3. The switching device according to claim 1, in which
the cut-off portions are arc.
